(19) United States
(12) Patent Application Publication
(10) Pub. No.: US 2026/0145117 A1
(43) Pub. Date: May 28, 2026

(54) ADSORPTION PROCESS

(71) Applicant: KOREA INSTITUTE OF ENERGY RESEARCH, Daejeon (KR)

(72) Inventors: Jong Ho PARK, Daejeon (KR); Hyung Jin YOON, Daejeon (KR); Jong Kee PARK, Daejeon (KR); Hee Tae BEUM, Daejeon (KR); Sang Sup HAN, Daejeon (KR); Ko Yeon CHOO, Daejeon (KR)

(73) Assignee: KOREA INSTITUTE OF ENERGY RESEARCH, Daejeon (KR)

(21) Appl. No.: 19/373,346

(22) Filed: Oct. 29, 2025

(30) Foreign Application Priority Data
Oct. 30, 2024 (KR) 10-2024-0150609

(51) Int. Cl. B01D 53/047; C01B 3/56

(52) U.S. Cl. CPC B01D 53/0476; C01B 3/56; B01D 2256/16; B01D 2257/504; B01D 2259/40013; B01D 2259/4003; B01D 2259/40035; B01D 2259/40043; B01D 2259/4061; C01B 2203/043; C01B 2203/0475

(57) ABSTRACT

An adsorptive separation method is disclosed. The adsorptive separation method of the present invention is a method for adsorptively separating a first gas from a mixed gas using a plurality of adsorption beds provided with an adsorbent selectively adsorbing the first gas, characterized by comprising an adsorption step, a depressurization step, a first rinse step, a second rinse step, a depressurization desorption step, a purge step, a pressurization step, a pressure increasing equalization and step, a repressurization step. According to the present invention, in the second rinse step, a high-purity first gas is introduced into the adsorption bed at a first pressure, and in the depressurization desorption step, the first gas is compressed to the first pressure by a compressor in a process of being transferred to a high-pressure product vessel, thereby making it possible to provide an adsorptive separation method configured to reduce power consumption by pressurizing a product gas of atmospheric pressure or higher discharged in a blowdown step to a pressure at which a rinse is performed, and to reduce power consumption used to create a recirculation stream used for the rinse.

### BACKGROUND

### 1. Technical Field

The present invention relates to an adsorptive separation method, and more particularly, to an adsorptive separation method configured to adsorb and separate a specific gas from a mixed gas.

### 2. Related Art

SMR (Steam Methane Reforming) generates a reformed gas containing H₂, CO, N₂, and CH₄ by causing a chemical reaction between methane gas contained in natural gas and steam through a catalyst at a predetermined pressure by an action of high temperature (700 to 1,000° C.). The reformed gas is introduced into a WGS (Water Gas Shift) reactor, so that CO is converted into H₂ and CO₂.

PSA (Pressure Swing Adsorption) adsorbs N₂, CO, CH₄, and CO₂, and extracts a high-purity hydrogen product through a pressure increase.

When a CO₂ VPSA (Vacuum Pressure Swing Adsorption) apparatus is installed between an SMR+WGS reactor and an H₂ PSA apparatus, the CO₂ VPSA apparatus extracts CO₂ to increase a partial pressure of H₂ of an H₂ PSA feed stream and increase an H₂ recovery rate.

In this regard, U.S. Pat. No. 8,709,136 (hereinafter, ‘Prior Document’) discloses an adsorption process.

The adsorption process of the Prior Document is a process of separating a first gas (CO₂) feed gas mixture containing the first gas and a second gas (H₂), and uses five or more adsorption beds containing an adsorbent selective to the first gas.

This process exposes each adsorption bed to a cycle repeated in an order of (a) a supply step, (b) a pressure decreasing equalization step, (c) an additional pressure depressurization step, (d) a blowdown step, (e) a purge step, (f) a rinse step, (g) a pressure increasing equalization step, and (h) a repressurization step.

The adsorption process of the Prior Document discloses a process of producing high-purity CO₂ by depressurizing to a vacuum in the blowdown step, and storing a CO₂ product in a product storage tank (CO₂ product tank). At this time, a component to be separated is a strong adsorption component, and a process (rinse step) of recirculating a high-concentration component (heavy component) obtained as a product must be performed for high purification of the component.
[Patent Documents] U.S. Pat. No. 8,709,136 (Registration Date: Apr. 29, 2014)

### SUMMARY

An object of the present invention is to provide an adsorptive separation method configured to reduce power consumption by pressurizing a product gas of atmospheric pressure or higher discharged in a blowdown step to a pressure at which a rinse is performed, and reduce power consumption used to create a recirculation stream used for the rinse.

The above object is achieved by, according to the present invention, a method for adsorptively separating a first gas from a mixed gas using a plurality of adsorption beds provided with an adsorbent selectively adsorbing the first gas, comprising: an adsorption step of supplying the mixed gas to the adsorption bed so that the adsorption bed adsorbs the first gas, and discharging a second gas separated from the first gas; a depressurization step of depressurizing the adsorption bed, for which the adsorption step is completed, to discharge the second gas existing in a void space of the adsorption bed and to concentrate the first gas; a first rinse step of transferring an off-gas having a higher concentration of the first gas than the mixed gas to the adsorption bed, for which the depressurization step is completed, to remove gas components other than the first gas; a second rinse step of transferring a high-purity first gas of a high-pressure product vessel to the adsorption bed, for which the first rinse step is completed, to remove gas components other than the first gas; a depressurization desorption step of depressurizing and desorbing the first gas adsorbed on the adsorption bed, for which the second rinse step is completed, and transferring the first gas to the high-pressure product vessel; a low-pressure cleaning step (purge step) of transferring a gas from an intermediate storage tank storing a portion of the gas discharged in the depressurization step to the adsorption bed, for which the depressurization desorption step is completed, to additionally desorb the first gas adsorbed on the adsorption bed for which the depressurization desorption is completed; a first partial pressurization step of transferring a portion of the gas of the intermediate storage tank storing the gas discharged in the depressurization step, and the off-gas discharged in the first rinse and the second rinse step to the adsorption bed, for which the low-pressure cleaning step is completed, to pressurize the adsorption bed; a pressure increasing equalization step of transferring a portion of the off-gas obtained in the depressurization step to the adsorption bed, for which the first partial pressurization is completed, to perform pressure increasing equalization; and a repressurization step of transferring high-concentration first gas of the intermediate storage tank through a compressor to the adsorption bed, for which the pressure increasing equalization is completed, to pressurize the adsorption tower for which a first pressure increasing equalization step is completed, wherein, in the second rinse step, the high-purity first gas is introduced into the adsorption bed at first a pressure, and the in depressurization desorption step, the first gas is introduced into a compressor while maintaining a pressure during depressurization, compressed to the first pressure or higher, and transferred to the high-pressure product vessel.

The plurality of adsorption beds include a first adsorption bed, a second adsorption bed, a third adsorption bed, a fourth adsorption bed, and a fifth adsorption bed, and the first adsorption bed, the second adsorption bed, the third adsorption bed, the fourth adsorption bed, and the fifth adsorption bed may be configured to each periodically adsorb and separate the first gas from the mixed gas.

The depressurization step may be configured to include: a pressure decreasing equalization step of connecting the adsorption bed for which the adsorption step is completed with the adsorption bed for which the first partial pressurization is completed to depressurize the adsorption bed for which the adsorption step is completed until pressures become equal; and a first co-current depressurization step of additionally depressurizing the adsorption bed for which the first pressure decreasing equalization step is completed.

When the low-pressure cleaning step is performed in the adsorption bed for which the depressurization desorption step is completed, the off-gas of the low-pressure cleaning step may be configured to be compressed through a compressor, transferred to the adsorption bed for which the depressurization step is completed, and used for the first rinse step.

The gas components discharged in the first rinse step and the second rinse step are transferred to the intermediate storage tank, wherein a portion may be configured to be introduced into the adsorption bed in the low-pressure cleaning step and utilized to perform the low-pressure cleaning step, and a portion may be configured to be compressed through a compressor, transferred to the adsorption bed for which the pressure increasing equalization is completed, and utilized for repressurization of the adsorption bed for which the pressure increasing equalization is completed.

A portion of the gas stored in the intermediate storage tank may be configured to be transferred to the low-pressure cleaning step and utilized for low-pressure cleaning, or utilized as fuel for supplying reaction heat of a methane steam reforming reaction process instead of being utilized for pressurization of the adsorption bed for which pressure increasing equalization is completed.

It may be configured to include a step of additionally pressure accumulating to a pressure at which the adsorption step proceeds by utilizing a portion of a high-concentration second gas discharged from the adsorption bed in which the adsorption step is in progress to the adsorption bed for which the repressurization is completed.

The depressurization step may be configured to include: a first pressure decreasing equalization step of connecting the adsorption bed for which the adsorption step is completed with the adsorption bed for which a second pressure increasing equalization is completed to make pressures of two towers equal, thereby depressurizing the pressure of the adsorption bed for which the adsorption step is completed; a cleaning supply step of connecting the adsorption bed for which the first pressure decreasing equalization is completed with the adsorption bed for which the depressurization desorption is completed to depressurize the adsorption bed for which the first pressure equalization is completed while supplying a gas for low-pressure cleaning of the adsorption bed for which the depressurization desorption is completed; a second pressure decreasing equalization step of connecting the adsorption bed for which the cleaning supply step is completed with the adsorption bed for which the first partial pressurization is completed to make pressures of two towers equal, thereby depressurizing the pressure of the adsorption bed for which the cleaning supply step is completed; and a first co-current depressurization step of connecting the adsorption bed for which the second pressure equalization depressurization step is completed with the intermediate storage tank storing the off-gas of the first rinse step and the second rinse step to additionally depressurize the pressure of the adsorption bed for which the second pressure decreasing equalization is completed.

The depressurization desorption is performed through two different pipes, wherein initial depressurization desorption of the depressurization desorption is performed through a pipe connected to a compressor compressing a high-concentration product gas, and may be configured to be performed through a compressor connected to a pipe performing the low-pressure cleaning after a predetermined time has elapsed. A final reached pressure of the adsorption tower during the depressurization desorption may become atmospheric pressure or lower in order to increase an effective adsorption amount of the adsorbent.

The above object is achieved by, according to the present invention, a method for adsorptively separating a first gas from a mixed gas using a plurality of adsorption beds provided with an adsorbent selectively adsorbing the first gas, comprising: an adsorption step of supplying the mixed gas to the adsorption bed so that the adsorption bed adsorbs the first gas, and discharging a second gas separated from the first gas; a depressurization step of discharging the first gas adsorbed on the adsorption bed to depressurize the adsorption bed; a first rinse step of transferring an off-gas having a higher concentration of the first gas than the mixed gas to the adsorption bed to remove gas components other than the first gas; a second rinse step of transferring a high-purity first gas of a high-pressure product vessel to the adsorption bed to remove gas components other than the first gas; a second depressurization step of connecting the adsorption bed, for which the second rinse step is completed, with the adsorption bed, for which a first partial pressurization is completed after low-pressure cleaning, to depressurize a pressure of the adsorption bed, for which the second rinse step is completed, in a same direction as a direction of a raw material while partially removing a high-concentration second component existing at an outlet part of the adsorption bed within the adsorption bed; a depressurization desorption step of depressurizing and desorbing the first gas adsorbed on the adsorption bed, for which the second depressurization step is completed, and transferring the first gas to the high-pressure product vessel; a low-pressure cleaning step of transferring a high-concentration first gas of an intermediate storage tank to the adsorption bed to perform low-pressure cleaning; a first partial pressurization step of transferring the high-concentration first gas of the intermediate storage tank to the adsorption bed to pressurize the adsorption bed; a second partial pressurization step of connecting the adsorption bed, for which the first partial pressurization is completed, with the adsorption bed, for which the second rinse step is completed, to increase a pressure of the adsorption bed for which the first partial pressurization is completed; a pressure increasing equalization step of connecting the adsorption bed, for which the second partial pressurization step is completed, with the adsorption bed, in which the depressurization is being performed, to pressurize the adsorption bed for which the second partial pressurization is completed; and a repressurization step of transferring a gas of the intermediate storage tank to the adsorption bed, for which the pressure increasing equalization step is completed, to pressurize the adsorption bed for which a first pressure increasing equalization step is completed, wherein, in the second rinse step, the high-purity first gas is introduced into the adsorption bed at a first pressure, and in the depressurization desorption step, the first gas is introduced into an inlet of a compressor while maintaining a pressure during depressurization, compressed to the first pressure or higher, and transferred to the high-pressure product vessel of a pressure higher than the first pressure.

The first gas may be configured to include CO₂, and the second gas may be configured to include H₂.

According to the present invention, in the second rinse step, the high-purity first gas is introduced into the adsorption bed at a first pressure, and in the depressurization desorption step, the first gas is compressed to the first pressure by a compressor in a process of being transferred to the high-pressure product vessel, thereby making it possible to provide an adsorptive separation method configured to reduce power consumption by pressurizing a product gas of atmospheric pressure or higher discharged in a blowdown step to a pressure at which a rinse is performed, and to reduce power consumption used to create a recirculation stream used for the rinse.

### BRIEF DESCRIPTION OF THE DRAWINGS

FIG. 1 is a diagram showing a CO₂ VPSA apparatus located between an SMR+WGS reactor and an H₂ PSA apparatus.

FIG. 2 is a schematic diagram showing a VPSA apparatus performing an adsorptive separation method according to an embodiment of the present invention.

FIG. 3 is a conceptual diagram showing a VPSA process configuration of the adsorptive separation method according to an embodiment of the present invention.

FIG. 4 is a diagram showing each step of the adsorptive separation method according to an embodiment of the present invention.

FIG. 5 is a diagram showing an operation of valves in each step of the adsorptive separation method according to an embodiment of the present invention.

FIG. 6 is a diagram showing each step of the adsorptive separation method according to another embodiment of the present invention.

FIG. 7 is a diagram showing each step of the adsorptive separation method according to yet another embodiment of the present invention.

FIG. 8 is a diagram showing each step of the adsorptive separation method according to an embodiment of the present invention.

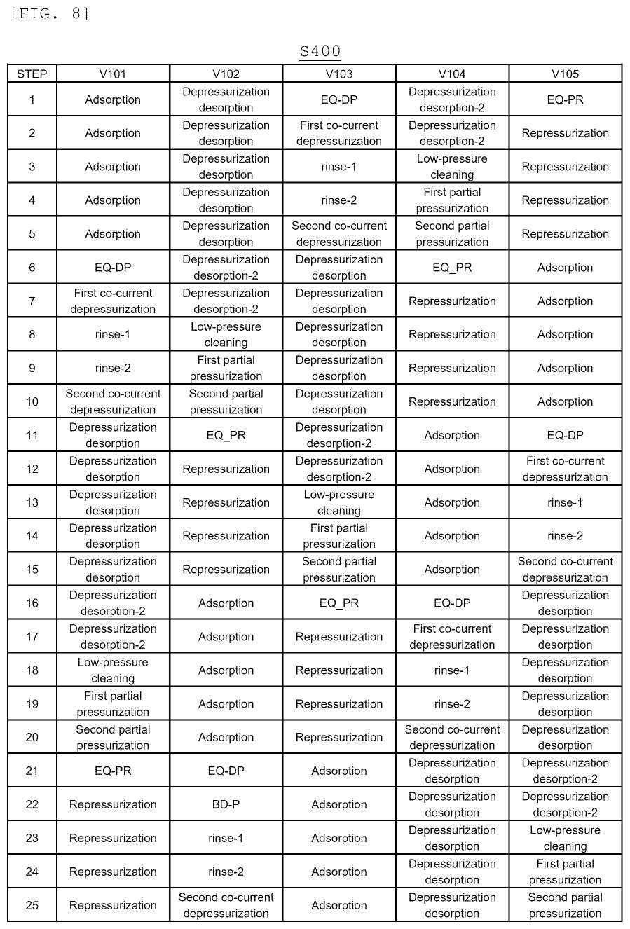

### DETAILED DESCRIPTION

Hereinafter, preferred embodiments of the present invention will be described in detail with reference to the accompanying drawings. However, in describing the present invention, descriptions of already known functions or configurations will be omitted to clarify the gist of the present invention.

Hereinafter, preferred embodiments of the present invention will be described in detail with reference to the accompanying drawings. However, in describing the present invention, descriptions of already known functions or configurations will be omitted to clarify the gist of the present invention.

The adsorptive separation method (S100) according to an embodiment of the present invention is configured to reduce power consumption by pressurizing a product gas of atmospheric pressure or higher discharged in a blowdown step to a pressure at which a rinse is performed, and to reduce power consumption used to create a recirculation stream used for the rinse.

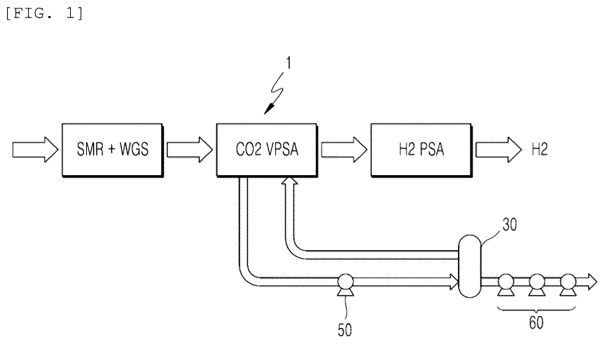

FIG. 1 is a diagram showing a CO₂ VPSA apparatus located between an SMR+WGS reactor and an H₂ PSA apparatus.

As shown in FIG. 1, SMR (Steam Methane Reforming) generates a reformed gas containing H₂, CO, N₂ and CH₄ by causing a chemical reaction between methane gas contained in natural gas and steam through a catalyst at a predetermined pressure by an action of high temperature (700 to 1,000° C.). The reformed gas is introduced into a WGS (Water Gas Shift) reactor, so that CO is converted into H₂ and CO₂.

H₂ PSA (Pressure Swing Adsorption) adsorbs H₂, CO, CH₄, and CO₂, and extracts a high-purity hydrogen product through a pressure increase.

When a CO₂ VPSA (Vacuum Pressure Swing Adsorption) apparatus is installed between an SMR+WGS reactor and an H₂ PSA apparatus, the CO₂ VPSA apparatus extracts CO₂ to increase a partial pressure of H₂ of an H₂ PSA feed stream and increase an H₂ recovery rate.

The adsorptive separation method (S100) according to an embodiment of the present invention discloses a method for adsorptively separating a first gas from a mixed gas using an adsorption separation system (1). The adsorption separation system (1) according to an embodiment of the present invention may refer to a CO₂ VPSA. The above-described first gas may include CO₂ gas.

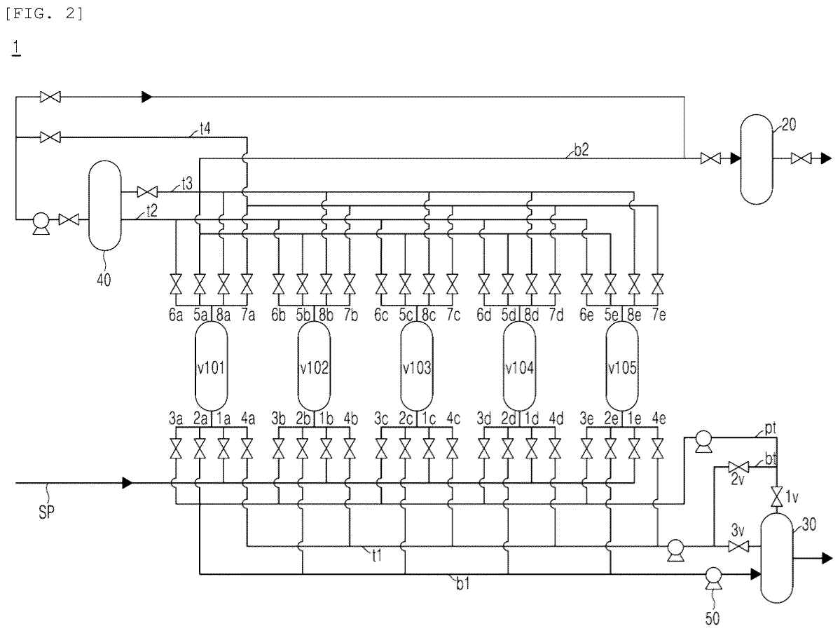

FIG. 2 is a schematic diagram showing a VPSA apparatus performing the adsorptive separation method (S100) according to an embodiment of the present invention.

As shown in FIG. 2, the adsorption separation system (1) includes a plurality of adsorption beds (10), a raffinate storage tank (20), a high-pressure product vessel (30), an intermediate storage tank (40), and a compressor (50).

The plurality of adsorption beds (10) include a first adsorption bed (V101), a second adsorption bed (V102), a third adsorption bed (V103), a fourth adsorption bed (V104), and a fifth adsorption bed (V105). The first adsorption bed (V101), the second adsorption bed (V102), the third adsorption bed (V103), the fourth adsorption bed (V104), and the fifth adsorption bed (V105) are provided with an adsorbent selectively adsorbing the first gas.

The first adsorption bed (V101), the second adsorption bed (V102), the third adsorption bed (V103), the fourth adsorption bed (V104), and the fifth adsorption bed (V105) may be connected to a supply pipe (sp), the raffinate storage tank (20), the high-pressure product vessel (30), and the intermediate storage tank (40) by a plurality of pipes and a plurality of valves. The supply pipe (sp) transfers the mixed gas. A control unit controls the plurality of valves for each step.

When the 1a valve is opened, the mixed gas is introduced into the first adsorption bed (V101). When the 2a valve is opened, the first adsorption bed (V101) and the high-pressure product vessel (30) are connected by the first discharge pipe (b1). When the 3a valve is opened, the first adsorption bed (V101) and the high-pressure product vessel (30) are connected by the purge pipe (pt). When the 4a valve is opened, the first adsorption bed (V101) and the high-pressure product vessel (30) are connected by the first conduit (t1).

When the 5a valve is opened, the first adsorption bed (V101) and the raffinate storage tank (20) are connected by the second discharge pipe (b2). When the 6a valve is opened, the first adsorption bed (V101) and the intermediate storage tank (40) are connected by the second conduit (t2). When the 7a valve is opened, the first adsorption bed (V101) and the intermediate storage tank (40) are connected by the fourth conduit (t4). When the 8a valve is opened, the first adsorption bed (V101) and the intermediate storage tank (40) are connected by the third conduit (t3).

When the 1b valve is opened, the mixed gas is introduced into the second adsorption bed (V102). When the 2b valve is opened, the second adsorption bed (V102) and the high-pressure product vessel (30) are connected by the first discharge pipe (b1). When the 3b valve is opened, the second adsorption bed (V102) and the high-pressure product vessel (30) are connected by the purge pipe (pt). When the 4b valve is opened, the second adsorption bed (V102) and the high-pressure product vessel (30) are connected by the first conduit (t1).

When the 5b valve is opened, the second adsorption bed (V102) and the raffinate storage tank (20) are connected by the second discharge pipe (b2). When the 6b valve is opened, the second adsorption bed (V102) and the intermediate storage tank (40) are connected by the second conduit (t2). When the 7b valve is opened, the second adsorption bed (V102) and the intermediate storage tank (40) are connected by the fourth conduit (t4). When the 8b valve is opened, the second adsorption bed (V102) and the intermediate storage tank (40) are connected by the third conduit (t3).

When the 1c valve is opened, the mixed gas is introduced into the third adsorption bed (V103). When the 2c valve is opened, the third adsorption bed (V103) and the high-pressure product vessel (30) are connected by the first discharge pipe (b1). When the 3c valve is opened, the third adsorption bed (V103) and the high-pressure product vessel (30) are connected by the purge pipe (pt). When the 4c valve is opened, the third adsorption bed (V103) and the high-pressure product vessel (30) are connected by the first conduit (t1).

When the 5c valve is opened, the third adsorption bed (V103) and the raffinate storage tank (20) are connected by the second discharge pipe (b2). When the 6c valve is opened, the third adsorption bed (V103) and the intermediate storage tank (40) are connected by the second conduit (t2). When the 7c valve is opened, the third adsorption bed (V103) and the intermediate storage tank (40) are connected by the fourth conduit (t4). When the 8c valve is opened, the third adsorption bed (V103) and the intermediate storage tank (40) are connected by the third conduit (t3).

When the 1d valve is opened, the mixed gas is introduced into the fourth adsorption bed (V104). When the 2d valve is opened, the fourth adsorption bed (V104) and the high-pressure product vessel (30) are connected by the first discharge pipe (b1). When the 3d valve is opened, the fourth adsorption bed (V104) and the high-pressure product vessel (30) are connected by the purge pipe (pt). When the 4d valve is opened, the fourth adsorption bed (V104) and the high-pressure product vessel (30) are connected by the first conduit (t1).

When the 5d valve is opened, the fourth adsorption bed (V104) and the raffinate storage tank (20) are connected by the second discharge pipe (b2). When the 6d valve is opened, the fourth adsorption bed (V104) and the intermediate storage tank (40) are connected by the second conduit (t2). When the 7d valve is opened, the fourth adsorption bed (V104) and the intermediate storage tank (40) are connected by the fourth conduit (t4). When the 8d valve is opened, the fourth adsorption bed (V104) and the intermediate storage tank (40) are connected by the third conduit (t3).

When the 1e valve is opened, the mixed gas is introduced into the fifth adsorption bed (V105). When the 2e valve is opened, the fifth adsorption bed (V105) and the high-pressure product vessel (30) are connected by the first discharge pipe (b1). When the 3e valve is opened, the fifth adsorption bed (V105) and the high-pressure product vessel (30) are connected by the purge pipe (pt). When the 4e valve is opened, the fifth adsorption bed (V105) and the high-pressure product vessel (30) are connected by the first conduit (t1).

When the 5e valve is opened, the fifth adsorption bed (V105) and the raffinate storage tank (20) are connected by the second discharge pipe (b2). When the 6e valve is opened, the fifth adsorption bed (V105) and the intermediate storage tank (40) are connected by the second conduit (t2). When the 7e valve is opened, the fifth adsorption bed (V105) and the intermediate storage tank (40) are connected by the fourth conduit (t4). When the 8e valve is opened, the fifth adsorption bed (V105) and the intermediate storage tank (40) are connected by the third conduit (t3).

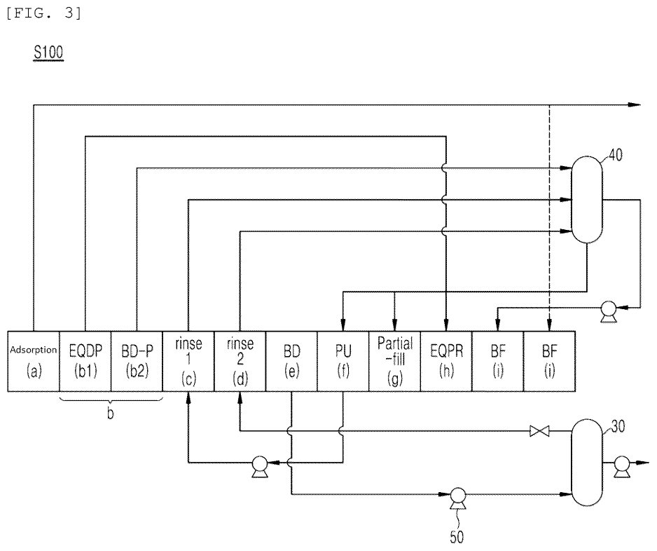

FIG. 3 is a conceptual diagram showing a VPSA process configuration of the adsorptive separation method (S100) according to an embodiment of the present invention.

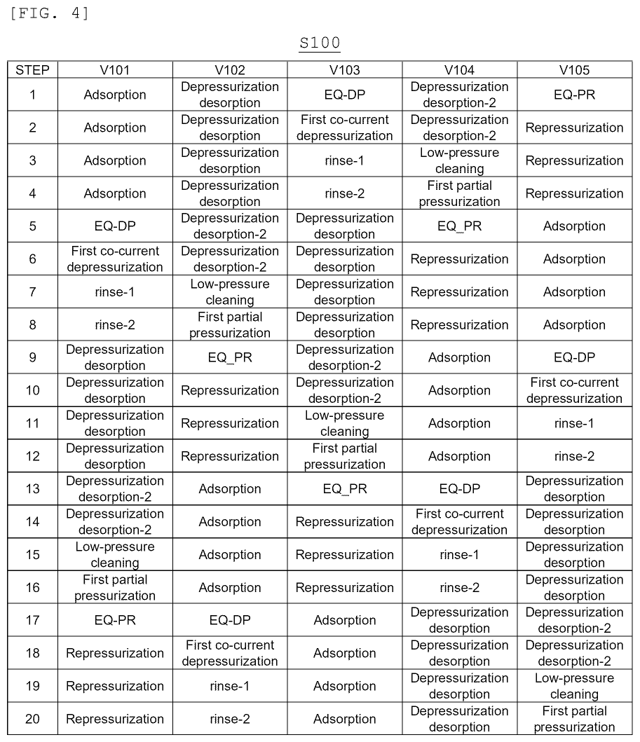

FIG. 4 is a diagram showing each step of the adsorptive separation method (S100) according to an embodiment of the present invention.

As shown in FIG. 4, the first adsorption bed (V101), the second adsorption bed (V102), the third adsorption bed (V103), the fourth adsorption bed (V104), and the fifth adsorption bed (V105) each periodically adsorb and separate the first gas from the mixed gas.

As shown in FIG. 3 and FIG. 4, the adsorptive separation method (S100) according to an embodiment of the present invention includes an adsorption step (a), a depressurization step (b), a first rinse step (c), a second rinse step (d), a depressurization desorption step (e), a purge step (f), a pressurization step (g), a pressure increasing equalization step (h), and a repressurization step (i). The adsorption separation system (1) according to an embodiment of the present invention may be easily understood through the adsorptive separation method (S100).

The adsorption step (a) is a step of supplying the mixed gas to the adsorption bed (10) so that the adsorption bed (10) adsorbs the first gas through the adsorbent, and discharging the second gas separated from the first gas to the raffinate storage tank (20). The above-described second gas may include H₂.

In Step 1, Step 2, Step 3, and Step 4, the first bed continuously performs the adsorption step (a). In Step 1, Step 2, Step 3, and Step 4, the second bed continuously performs the depressurization desorption step (e) (refer to FIG. 4).

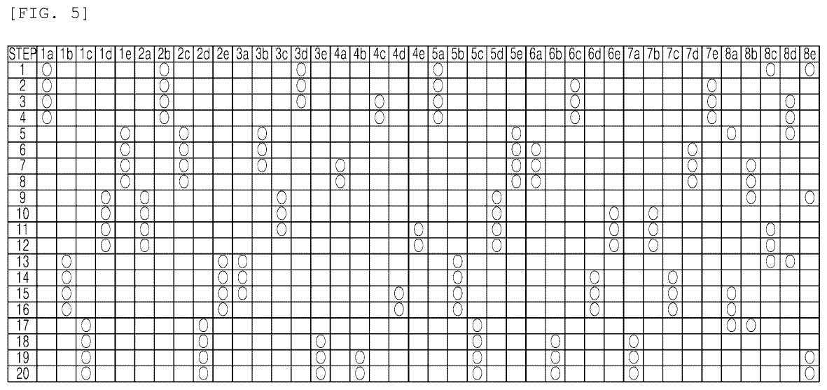

In Step 1, the control unit opens the 1a valve, 2b valve, 3d valve, 5a valve, 8c valve, and 8e valve (refer to FIG. 5).

In Step 1, the first bed performs the adsorption step (a), the second bed performs the depressurization desorption step (e), the third bed performs the pressure decreasing equalization step (b1), the fourth bed performs the depressurization desorption step (e), and the fifth bed performs the pressure increasing equalization step (h) (refer to FIG. 4).

In Step 2, the control unit opens the 1a valve, 2b valve, 3d valve, 5a valve, 6c valve, and 7e valve (refer to FIG. 5).

In Step 2, the first adsorption bed (V101) performs the adsorption step (a), the second adsorption bed (V102) performs the depressurization desorption step (e), the third adsorption bed (V103) performs the additional depressurization step (b2), the fourth adsorption bed (V104) performs the purge step (f), and the fifth adsorption bed (V105) performs the repressurization step (i) (refer to FIG. 4).

In Step 3, the control unit opens the 1a valve, 2b valve, 3d valve, 4c valve, 5a valve, 6c valve, 7e valve, and 8d valve (refer to FIG. 5).

In Step 3, the first adsorption bed (V101) performs the adsorption step (a), the second adsorption bed (V102) performs the depressurization desorption step (e), the third adsorption bed (V103) performs the first rinse step (c), the fourth adsorption bed (V104) performs the purge step (f), and the fifth adsorption bed (V105) performs the repressurization step (i) (refer to FIG. 4).

In Step 4, the control unit opens the 1a valve, 2b valve, 4c valve, 5a valve, 6c valve, 7e valve, and 8d valve (refer to FIG. 5).

In Step 4, the first adsorption bed (V101) performs the adsorption step (a), the second adsorption bed (V102) performs the depressurization desorption step (e), the third adsorption bed (V103) performs the second rinse step (d), the fourth adsorption bed (V104) performs the pressurization step (g), and the fifth adsorption bed (V105) performs the repressurization step (i) (refer to FIG. 4).

The depressurization step (b) is a step of discharging the first gas adsorbed on the adsorption bed (10) to depressurize the adsorption bed (10). The depressurization step (b) includes a pressure decreasing equalization step (b1) and an additional depressurization step (b2).

Based on the first adsorption bed (V101), the pressure decreasing equalization step (b1) is a step of transferring the first gas adsorbed on the first adsorption bed (V101) to the fifth adsorption bed (V105) to perform pressure decreasing equalization of the first adsorption bed (V101). When the first adsorption bed (V101) performs the pressure decreasing equalization step (b1), the fifth adsorption bed (V105) performs the pressure increasing equalization step (h).

In Step 5, the control unit opens the 1e valve, 2c valve, 3b valve, 5e valve, 8a valve, and 8d valve (refer to FIG. 5).

In Step 5, the first adsorption bed (V101) performs the pressure decreasing equalization step (b1), the second adsorption bed (V102) performs the depressurization desorption step (e), the third adsorption bed (V103) performs the depressurization desorption step (e), the fourth adsorption bed (V104) performs the pressure increasing equalization step (EQ_PR), and the fifth adsorption bed (V105) performs the adsorption step (a) (refer to FIG. 4).

Based on the first adsorption bed (V101), the additional depressurization step (b2) is a step of transferring the first gas adsorbed on the first adsorption bed (V101) to the intermediate storage tank (40) to depressurize the adsorption bed (10).

In Step 6, the control unit opens the 1e valve, 2c valve, 3b valve, 5e valve, 6a valve, and 7d valve (refer to FIG. 5).

In Step 6, the first adsorption bed (V101) performs the additional depressurization step (b2), the second adsorption bed (V102) performs the purge step (f), the third adsorption bed (V103) performs the depressurization desorption step (e), the fourth adsorption bed (V104) performs the repressurization step (i), and the fifth adsorption bed (V105) performs the adsorption step (a) (refer to FIG. 4).

The first rinse step (c) is a step of transferring an off-gas having a higher concentration of the first gas than the mixed gas to the adsorption bed (10) to remove gas components other than the first gas. The gas components discharged in the first rinse step (c) are transferred to the intermediate storage tank (40).

In Step 7, the control unit opens the 1e valve, 2c valve, 3b valve, 4a valve, 5e valve, 6a valve, 7d valve, and 8b valve (refer to FIG. 5).

In Step 7, the first adsorption bed (V101) performs the first rinse step (c), the second adsorption bed (V102) performs the purge step (f), the third adsorption bed (V103) performs the depressurization desorption step (e), the fourth adsorption bed (V104) performs the repressurization step (i), and the fifth adsorption bed (V105) performs the adsorption step (a) (refer to FIG. 4).

Based on Step 7, when the second adsorption bed (V102) performs the purge step (f), the control unit closes the 1v opening/closing valve and the 3v opening/closing valve, and opens the 2v opening/closing valve. When the 2v opening/closing valve is opened, the first conduit (t1) and the purge pipe (pt) are connected by the bypass pipe (bt). Therefore, the off-gas of the second adsorption bed (V102) is used for the first rinse step (c) of the first adsorption bed (V101).

The second rinse step (d) is a step of transferring the high-purity first gas of the high-pressure product vessel (30) to the adsorption bed (10) to remove gas components other than the first gas. The gas components discharged in the second rinse step (d) are transferred to the intermediate storage tank (40).

In Step 8, the control unit opens the 1e valve, 2c valve, 4a valve, 5e valve, 6a valve, 7d valve, and 8b valve (refer to FIG. 5).

In Step 8, the first adsorption bed (V101) performs the second rinse step (d), the second adsorption bed (V102) performs the pressurization step (g), the third adsorption bed (V103) performs the depressurization desorption step (e), the fourth adsorption bed (V104) performs the repressurization step (i), and the fifth adsorption bed (V105) performs the adsorption step (a) (refer to FIG. 4).

The depressurization desorption step (e) is a step of depressurizing and desorbing the first gas adsorbed on the adsorption bed (10) and transferring the first gas to the high-pressure product vessel (30).

In the depressurization desorption step (e), the first gas is compressed to a first pressure by the compressor (50) in a process of being transferred to the high-pressure product vessel (30), and in the second rinse step (d), the high-purity first gas is introduced into the adsorption bed (10) at the first pressure.

As shown in FIG. 1, in order to store CO₂ purified to high purity of the high-pressure product vessel (30) underground or store CO₂ by liquefaction, a step of compressing to at least 25 bar or higher is required. High-pressure compression is performed using a multi-stage compressor (60) (an 8-stage compressor is used when compressing to 140 bar).

The adsorptive separation method (S100) according to an embodiment of the present invention pressurizes the gas discharged in the depressurization desorption step (e; BD) to a first pressure (a pressure at which a rinse is performed) higher than atmospheric pressure through the compressor (50).

As an example, in the adsorptive separation method (S100) according to an embodiment of the present invention, an adsorption pressure of the adsorption step (a), a rinse pressure of the first rinse step (c) and the second rinse step (d), and a desorption pressure of the depressurization desorption step (e) may be as shown in [Table 1] below.

TABLE 1

| Raw material concentration | 1% CO, 4% CH₄, 20% CO₂, 75% H₂ | |
|---|---|---|
| Raw material flow rate | 1560 | Nm³/hr |
| Adsorption pressure | 15 | barg |
| Desorption pressure | −0.4 | barg |
| Rinse pressure | 2.5 | barg |

Therefore, compared to depressurizing to the existing atmospheric pressure and then compressing again to the rinse pressure (pressure at which a rinse is performed), it is possible to reduce power consumption required to pressurize to the rinse pressure. In addition, power used to create a recirculation stream used for the rinse can also be reduced. In Step 9, Step 10, Step 11, Step 12, and Step 13, the first bed continuously performs the depressurization desorption step (e) (refer to FIG. 4). In Step 9, the control unit opens the 1d valve, 2a valve, 3c valve, 5d valve, 8b valve, and 8e valve (refer to FIG. 5). In Step 9, the first adsorption bed (V101) performs the depressurization desorption step (e), the second adsorption bed (V102) performs EQ_PR, the third adsorption bed (V103) performs the depressurization desorption step (e), the fourth adsorption bed (V104) performs the adsorption step (a), and the fifth adsorption bed (V105) performs the pressure decreasing equalization step (b1) (refer to FIG. 4).

In Step 10, the control unit opens the 1d valve, 2a valve, 3c valve, 5d valve, 6e valve, and 7b valve (refer to FIG. 5).

In Step 10, the first adsorption bed (V101) performs the depressurization desorption step (e), the second adsorption bed (V102) performs the repressurization step (i), the third adsorption bed (V103) performs the purge step (f), the fourth adsorption bed (V104) performs the adsorption step (a), and the fifth adsorption bed (V105) performs the additional depressurization step (b2) (refer to FIG. 4).

In Step 11, the control unit opens the 1d valve, 2a valve, 3c valve, 4e valve, 5d valve, 6e valve, 7b valve, and 8c valve (refer to FIG. 5).

In Step 11, the first adsorption bed (V101) performs the depressurization desorption step (e), the second adsorption bed (V102) performs the repressurization step (i), the third adsorption bed (V103) performs the purge step (f), the fourth adsorption bed (V104) performs the adsorption step (a), and the fifth adsorption bed (V105) performs the first rinse step (c) (refer to FIG. 4).

In Step 12, the control unit opens the 1d valve, 2a valve, 4e valve, 5d valve, 6e valve, 7b valve, and 8c valve (refer to FIG. 5).

In Step 12, the first adsorption bed (V101) performs the depressurization desorption step (e), the second adsorption bed (V102) performs the repressurization step (i), the third adsorption bed (V103) performs the pressurization step (g), the fourth adsorption bed (V104) performs the adsorption step (a), and the fifth adsorption bed (V105) performs the second rinse step (d) (refer to FIG. 4).

In Step 13, the control unit opens the 1b valve, 2e valve, 3a valve, 5b valve, 8c valve, and 8d valve (refer to FIG. 5).

In Step 13, the first adsorption bed (V101) performs the depressurization desorption step (e), the second adsorption bed (V102) performs the adsorption step (a), the third adsorption bed (V103) performs the pressure increasing equalization step (EQ_PR), the fourth adsorption bed (V104) performs the pressure decreasing equalization step (b1), and the fifth adsorption bed (V105) performs the depressurization desorption step (e) (refer to FIG. 4).

In Step 9, Step 10, Step 11, and Step 12, the first gas depressurized and desorbed in the first adsorption bed (V101) is transferred to the high-pressure product vessel (30) through the first discharge pipe (b1). In Step 13, the first gas depressurized and desorbed in the first adsorption bed (V101) is transferred to the high-pressure product vessel (30) through the purge pipe (pt).

The purge step (f) is a step of transferring the high-concentration first gas of the intermediate storage tank (40) to the adsorption bed (10) to perform low-pressure cleaning.

A significant amount of high-concentration CO₂ exists inside the adsorption bed (10) for which the depressurization desorption is completed. If this is recovered and utilized, productivity of the process can be increased, and a recirculation amount of a high-purity product can be reduced.

When the first adsorption bed (V101) performs the purge step (f), the control unit closes the 1v opening/closing valve and the 3v opening/closing valve, and opens the 2v opening/closing valve. When the 2v opening/closing valve is opened, the first conduit (t1) and the purge pipe (pt) are connected by the bypass pipe (bt). Therefore, the off-gas of the first adsorption bed (V101) is used for the first rinse step (c) of the fourth adsorption bed (V104).

In Step 14, the control unit opens the 1b valve, 2e valve, 3a valve, 5b valve, 6d valve, and 7c valve (refer to FIG. 5).

In Step 14, the first adsorption bed (V101) performs the purge step (f), the second adsorption bed (V102) performs the adsorption step (a), the third adsorption bed (V103) performs the repressurization step (i), the fourth adsorption bed (V104) performs the additional depressurization step (b2), and the fifth adsorption bed (V105) performs the depressurization desorption step (e) (refer to FIG. 4).

In Step 15, the control unit opens the 1b valve, 2e valve, 3a valve, 4d valve, 5b valve, 6d valve, 7c valve, and 8a valve (refer to FIG. 5).

In Step 15, the first adsorption bed (V101) performs the purge step (f), the second adsorption bed (V102) performs the adsorption step (a), the third adsorption bed (V103) performs the repressurization step (i), the fourth adsorption bed (V104) performs the first rinse step (c), and the fifth adsorption bed (V105) performs the depressurization desorption step (e) (refer to FIG. 4).

The pressurization step (g) is a step of transferring the high-concentration first gas of the intermediate storage tank (40) to the adsorption bed (10) to pressurize the adsorption bed (10).

In Step 16, the control unit opens the 1b valve, 2e valve, 4d valve, 5b valve, 6d valve, 7c valve, and 8a valve (refer to FIG. 5).

In Step 16, the first adsorption bed (V101) performs the pressurization step (g), the second adsorption bed (V102) performs the adsorption step (a), the third adsorption bed (V103) performs the repressurization step (i), the fourth adsorption bed (V104) performs the second rinse step (d), and the fifth adsorption bed (V105) performs the depressurization desorption step (e) (refer to FIG. 4).

The pressure increasing equalization step (h) is a step of transferring an off-gas having a higher concentration of the first gas than the mixed gas to the adsorption bed (10) to perform pressure increasing equalization. When the first adsorption bed (V101) performs the pressure increasing equalization step (h), the second adsorption bed (V102) performs the pressure decreasing equalization step (b1).

In Step 17, the control unit opens the 1c valve, 2d valve, 3e valve, 5c valve, 8a valve, and 8b valve (refer to FIG. 5).

In Step 17, the first adsorption bed (V101) performs the pressure increasing equalization step (h), the second adsorption bed (V102) performs the pressure decreasing equalization step (b1), the third adsorption bed (V103) performs the adsorption step (a), the fourth adsorption bed (V104) performs the depressurization desorption step (e), and the fifth adsorption bed (V105) performs the depressurization desorption step (e) (refer to FIG. 4).

The repressurization step (i) is a step of transferring the high-concentration first gas of the intermediate storage tank (40) to the adsorption bed (10) to pressurize the adsorption bed (10). In Step 18, Step 19, and Step 20, the first bed continuously performs the repressurization step (i).

In Step 18, the control unit opens the 1c valve, 2d valve, 3e valve, 5c valve, 6b valve, and 7a valve (refer to FIG. 5).

In Step 18, the first adsorption bed (V101) performs the repressurization step (i), the second adsorption bed (V102) performs the additional depressurization step (b2), the third adsorption bed (V103) performs the adsorption step (a), the fourth adsorption bed (V104) performs the depressurization desorption step (e), and the fifth adsorption bed (V105) performs the purge step (f) (refer to FIG. 4).

In Step 19, the control unit opens the 1c valve, 2d valve, 3e valve, 4b valve, 5c valve, 6b valve, 7a valve, and 8e valve (refer to FIG. 5).

In Step 19, the first adsorption bed (V101) performs the repressurization step (i), the second adsorption bed (V102) performs the first rinse step (c), the third adsorption bed (V103) performs the adsorption step (a), the fourth adsorption bed (V104) performs the depressurization desorption step (e), and the fifth adsorption bed (V105) performs the purge step (f) (refer to FIG. 4).

In Step 20, the control unit opens the 1c valve, 2d valve, 4b valve, 5c valve, 6b valve, 7a valve, and 8e valve (refer to FIG. 5).

In Step 20, the first adsorption bed (V101) performs the repressurization step (i), the second adsorption bed (V102) performs the second rinse step (d), the third adsorption bed (V103) performs the adsorption step (a), the fourth adsorption bed (V104) performs the depressurization desorption step (e), and the fifth adsorption bed (V105) performs the pressurization step (g) (refer to FIG. 4).

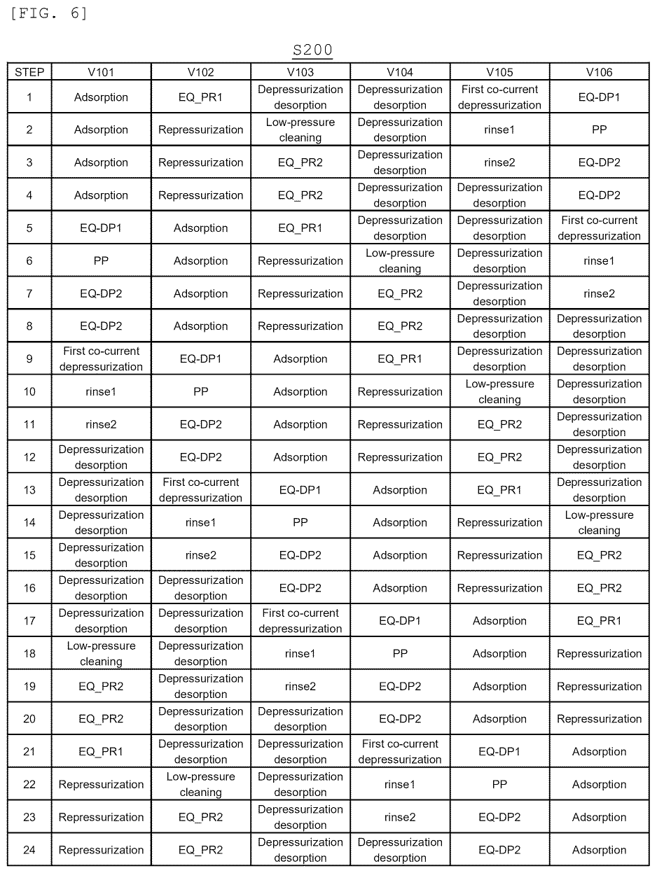

FIG. 6 is a diagram showing each step of the adsorptive separation method (S200) according to another embodiment of the present invention.

The plurality of adsorption beds (10) may further include a sixth adsorption bed (V106). The sixth adsorption bed (V106) may be provided with an adsorbent selectively adsorbing the first gas.

As shown in FIG. 6, the first adsorption bed (V101), the second adsorption bed (V102), the third adsorption bed (V103), the fourth adsorption bed (V104), the fifth adsorption bed (V105), and the sixth adsorption bed (V106) may each periodically adsorb and separate the first gas from the mixed gas.

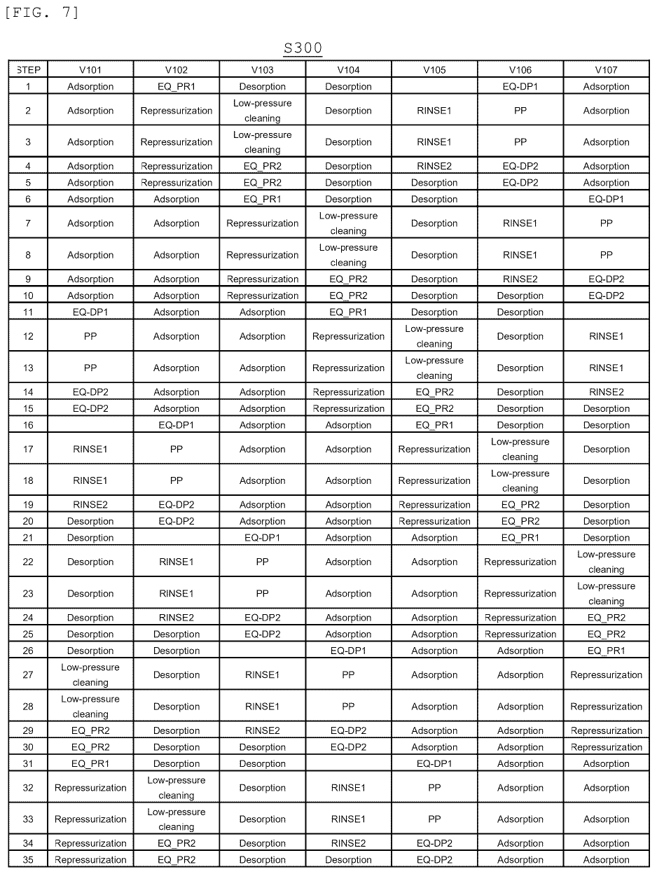

FIG. 7 is a diagram showing each step of the adsorptive separation method (S300) according to yet another embodiment of the present invention. The plurality of adsorption beds (10) may further include a seventh adsorption bed (V107). The seventh adsorption bed (V107) may be provided with an adsorbent selectively adsorbing the first gas.

As shown in FIG. 7, the first adsorption bed (V101), the second adsorption bed (V102), the third adsorption bed (V103), the fourth adsorption bed (V104), the fifth adsorption bed (V105), the sixth adsorption bed (V106), and the seventh adsorption bed (V107) may each periodically adsorb and separate the first gas from the mixed gas.

According to the present invention, in the second rinse step (d), the high-purity first gas is introduced into the adsorption bed (10) at a first pressure, and in the depressurization desorption step (e), the first gas is compressed to the first pressure by the compressor (50) in a process of being transferred to the high-pressure product vessel (30), thereby making it possible to provide the adsorptive separation method (S100) configured to reduce power consumption by pressurizing a product gas of atmospheric pressure or higher discharged in a blowdown step to a pressure at which a rinse is performed, and to reduce power consumption used to create a recirculation stream used for the rinse.

Although specific embodiments of the present invention have been described and shown above, the present invention is not limited to the described embodiments, and it is obvious to those skilled in the art that various modifications and variations can be made without departing from the spirit and scope of the present invention. Therefore, such modifications or variations should not be understood individually from the technical spirit or point of view of the present invention, and the modified embodiments should be said to fall within the scope of the claims of the present invention.

[Description of Reference Numerals]

| | |
|---|---|
| S100: Adsorptive separation method | |
| a: Adsorption step | |
| e: Depressurization desorption step | |
| b: Depressurization step | f: Purge step |
| b1: Pressure decreasing equalization step | |
| g: Pressurization step | |
| b2: Additional depressurization step | |
| h: Pressure increasing equalization step | |
| c: First rinse step | i: Repressurization step |
| d: Second rinse step | |
| 1: Adsorption separation system | |
| 10: Adsorption bed | 20: Raffinate storage tank |
| V101: First adsorption bed | |
| 30: High-pressure product vessel | |
| V102: Second adsorption bed | |
| 40: Intermediate storage tank | |
| V103: Third adsorption bed | 50: Compressor |
| V104: Fourth adsorption bed | |
| 60: Multi-stage compressor | |
| V105: Fifth adsorption bed | |

What is claimed is:

1. An adsorptive separation method for adsorptively separating a first gas from a mixed gas using a plurality of adsorption beds provided with an adsorbent selectively adsorbing the first gas, the method comprising:
an adsorption step of supplying the mixed gas to the adsorption bed so that the adsorption bed adsorbs the first gas, and discharges a second gas separated from the first gas;
a depressurization step of depressurizing the adsorption bed, for which the adsorption step is completed, discharging the second gas existing in a void space of the adsorption bed and concentrating the first gas;
a first rinse step of transferring an off-gas having a higher concentration of the first gas than the mixed gas to the adsorption bed, for which the depressurization step is completed, to remove gas components other than the first gas;
a second rinse step of transferring a high-purity first gas of a high-pressure product vessel to the adsorption bed, for which the first rinse step is completed, to remove gas components other than the first gas;
a depressurization desorption step of depressurizing and desorbing the first gas adsorbed on the adsorption bed, for which the second rinse step is completed, and transferring the first gas to the high-pressure product vessel;
a low-pressure cleaning step (purge step) of transferring a gas from an intermediate storage tank storing a portion of the gas discharged in the depressurization step to the adsorption bed, for which the depressurization desorption step is completed, to additionally desorb the first gas adsorbed on the adsorption bed for which the depressurization desorption is completed;
a first partial pressurization step of pressurizing the adsorption bed, for which the low-pressure cleaning step is completed, by transferring a portion of the gas of the intermediate storage tank storing the gas discharged in the depressurization step, and the off-gas discharged in the first rinse and the second rinse step to the adsorption bed;
a pressure increasing equalization step of pressure equalizing and pressurizing the adsorption bed, for which the first partial pressurization is completed, by transferring a portion of the off-gas obtained in the depressurization step to the adsorption bed;
and a repressurization step of pressurizing the adsorption bed, for which the pressure equalization pressurization is completed, by transferring a high-concentration first gas of the intermediate storage tank to the adsorption bed,
wherein, in the second rinse step, the high-purity first gas is introduced into the adsorption bed at a first pressure,
and in the depressurization desorption step, the first gas is introduced into a compressor while maintaining a pressure during depressurization, compressed to the first pressure or higher, and transferred to the high-pressure product vessel.

2. The adsorptive separation method of claim 1, wherein the plurality of adsorption beds includes a first adsorption bed, a second adsorption bed, a third adsorption bed, a fourth adsorption bed, and a fifth adsorption bed,
and wherein the first adsorption bed, the second adsorption bed, the third adsorption bed, the fourth adsorption bed, and the fifth adsorption bed each periodically adsorbs and separates the first gas from the mixed gas.

3. The adsorptive separation method of claim 1, wherein the depressurization step includes:
a pressure step of decreasing equalization depressurizing by connecting the adsorption bed for which the adsorption step is completed with the adsorption bed for which the first partial pressurization is completed;
and a first co-current depressurization step of depressurizing the adsorption bed, for which the first pressure equalization depressurization step is completed, by connecting the adsorption bed to the intermediate storage tank.

4. The adsorptive separation method of claim 1, wherein, when the low-pressure cleaning step is performed in the adsorption bed for which the depressurization desorption step is completed, the off-gas of the low-pressure cleaning step is compressed through a compressor, transferred to the adsorption bed for which the depressurization step is completed, and used in the first rinse step.

5. The adsorptive separation method of claim 1, wherein the gas components discharged in the first rinse step and the second rinse step are transferred to the intermediate storage tank, a portion thereof is introduced into the adsorption bed in the low-pressure cleaning step and utilized to perform the low-pressure cleaning step, and another portion is compressed through a compressor, transferred to the adsorption bed for which the pressure increasing equalization is completed, and utilized for repressurization of the adsorption bed for which the pressure increasing equalization is completed.

6. The adsorptive separation method of claim 1, wherein a portion of the gas discharged in the first rinse step and the second rinse step is introduced into the adsorption bed in the low-pressure cleaning step and utilized to perform the low-pressure cleaning step, a portion is transferred to the adsorption bed and utilized for pressure increasing equalization, and a portion is also utilized as fuel for supplying reaction heat of a steam methane reforming reaction process.

7. The adsorptive separation method of claim 3, wherein the depressurization step includes: a first pressure decreasing equalization step of connecting the adsorption bed for which the adsorption step is completed with the adsorption bed for which a second pressure increasing equalization is completed to make pressures of two towers equal, thereby depressurizing the pressure of the adsorption bed for which the adsorption step is completed;
a cleaning supply step of connecting the adsorption bed for which the first pressure decreasing equalization is completed with the adsorption bed for which the depressurization desorption is completed to depressurize the adsorption bed for which the first pressure equalization is completed while supplying a gas for low-pressure cleaning of the adsorption bed for which the depressurization desorption is completed;
a second pressure decreasing equalization step of connecting the adsorption bed for which the cleaning supply step is completed with the adsorption bed for which the first partial pressurization is completed to make pressures of two towers equal, thereby depressurizing the pressure of the adsorption bed for which the cleaning supply step is completed;
and a first co-current depressurization step of connecting the adsorption bed for which the second pressure decreasing equalization step is completed with the intermediate storage tank storing the off-gas of the first rinse step and the second rinse step to additionally depressurize the pressure of the adsorption bed for which the second pressure decreasing equalization is completed.

8. The adsorptive separation method of claim 1, wherein the depressurization desorption is performed through two different pipes, wherein initial depressurization desorption of the depressurization desorption is performed through a pipe connected to a compressor compressing a high-concentration product gas, and after a predetermined time elapse, the depressurization desorption is performed through a compressor connected to a pipe performing the low-pressure cleaning.

9. An adsorptive separation method for adsorptively separating a first gas from a mixed gas using a plurality of adsorption beds provided with an adsorbent selectively adsorbing the first gas, the method comprising:
an adsorption step of supplying the mixed gas to the adsorption bed so that the adsorption bed adsorbs the first gas, and discharges a second gas separated from the first gas;
a depressurization step of discharging the first gas adsorbed on the adsorption bed to depressurize the adsorption bed;
a first rinse step of transferring an off-gas having a higher concentration of the first gas than the mixed gas to the adsorption bed to remove gas components other than the first gas;
a second rinse step of transferring a high-purity first gas of a high-pressure product vessel to the adsorption bed to remove gas components other than the first gas;
a second depressurization step of connecting the adsorption bed, for which the second rinse step is completed, with the adsorption bed, for which a first partial pressurization is completed after low-pressure cleaning, to depressurize a pressure of the adsorption bed, for which the second rinse step is completed, in a same direction as a direction of a raw material while partially removing a high-concentration second component existing at an outlet part of the adsorption bed within the adsorption bed;
a depressurization desorption step of depressurizing and desorbing the first gas adsorbed on the adsorption bed, for which the second depressurization step is completed, and transferring the first gas to the high-pressure product vessel;
a low-pressure cleaning step of transferring a high-concentration first gas of an intermediate storage tank to the adsorption bed to perform low-pressure cleaning;
a first partial pressurization step of transferring the high-concentration first gas of the intermediate storage tank to the adsorption bed to pressurize the adsorption bed;
a second partial pressurization step of connecting the adsorption bed, for which the first partial pressurization is completed, with the adsorption bed, for which the second rinse step is completed, to increase a pressure of the adsorption bed for which the first partial pressurization is completed;
a pressure increasing equalization step of connecting the adsorption bed, for which the second partial pressurization step is completed, with the adsorption bed, in which the depressurization is being performed, to pressurize the adsorption bed for which the second partial pressurization is completed;
and a repressurization step of transferring a gas of the intermediate storage tank to the adsorption bed, for which the pressure increasing equalization step is completed, to pressurize the adsorption bed for which a first pressure increasing equalization step is completed,
wherein, in the second rinse step, the high-purity first gas is introduced into the adsorption bed at a first pressure,
and in the depressurization desorption step, the first gas is introduced into an inlet of a compressor while maintaining a pressure during depressurization, and transferred to the high-pressure product vessel of a pressure higher than the first pressure.

10. The adsorptive separation method of claim 1, wherein the first gas includes CO₂, and wherein the second gas includes H₂.
